(19) United States
(12) Patent Application Publication
(10) Pub. No.: US 2018/0150802 A1
(43) Pub. Date: May 31, 2018

(54) UNIFIED CROSS-PLATFORM JOB APPLICATION INTERFACE

(71) Applicant: Surfin Mouse LLC, New York, NY (US)

(72) Inventor: Joshua Blumenfeld, New York, NY (US)

(21) Appl. No.: 15/365,516

(22) Filed: Nov. 30, 2016

(51) Int. Cl. G06Q 10/10; G06F 17/30

(52) U.S. Cl. CPC G06Q 10/1053; G06F 17/30882; G06F 17/30923; G06F 17/30887

(57) ABSTRACT

Unified cross-platform job application interfaces are provided. In various embodiments, a plurality of job descriptions is received from an external system. For each of the plurality of job descriptions, a landing page is generated. Each landing page is made available via the internet at a URL. A feed is generated comprising the URL of each landing page. The feed is made available via the internet at a URL. A user request is received for at least one of the landing pages via the internet. Contact information is collected from the user. The landing page is provided to the user. The landing page comprises one of the plurality of job descriptions. It is detected that the user has not completed a job application correspond to the one of the plurality of job descriptions. The user is provided a link to complete the job application.

### BACKGROUND

Embodiments of the present invention relate to facilitating continuous cross-platform interactions, and more specifically, to unified cross-platform job application interfaces.

### BRIEF SUMMARY

According to embodiments of the present disclosure, methods of and computer program products for a cross-platform job application are provided. A plurality of job descriptions is received from an external system. For each of the plurality of job descriptions, a landing page is generated. Each landing page is made available via the internet at a URL. A feed is generated comprising the URL of each landing page. The feed is made available via the internet at a URL. A user request is received for at least one of the landing pages via the internet. Contact information is collected from the user. The landing page is provided to the user. The landing page comprises one of the plurality of job descriptions. It is detected that the user has not completed a job application correspond to the one of the plurality of job descriptions. The user is provided a link to complete the job application.

### BRIEF DESCRIPTION OF THE SEVERAL VIEWS OF THE DRAWINGS

FIG. 1 illustrates a system for providing a unified cross-platform job application interface according to embodiments of the present disclosure.

FIG. 2 illustrates a method of providing a unified cross-platform job application interface according to embodiments of the present disclosure.

FIG. 3 illustrates a method for cross-platform tracking of a job applicant according to various embodiments.

FIG. 4 depicts a computing node according to an embodiment of the present invention.

### DETAILED DESCRIPTION

Mobile traffic to online employment applications has increased significantly over the past 5 years. However, despite the substantial increase in smart phone adoption, job application rates are up to 66% lower on mobile phones compared to desktop computers. One factor contributing to this disparity is the inflexibility of many smart phone environments with respect to document management. In particular, there is no streamlined way to store and retrieve documents such as résumés and cover letters in a mobile environment such as provided by the iPhone, which in turn limits a user's ability to submit job applications from such platforms. There is likewise no streamlined way to create or modify such documents to tailor them to a given job application, both due to the limitations of mobile software and due to the small form factor of the average mobile device. Accordingly, although a user may browse job opportunities using a web interface or a custom app on a mobile device, the ability to make complete submissions is severely limited.

Job candidates also lack a means to transparently continue an application session on a more robust device. In particular, web-based and app-based interfaces do not provide the ability to send an application and its state to a desktop or other remote computer, and do not provide the continuity necessary for future completion of an application.

In addition to the limitations discussed above with regard to user devices, employers also lack means to allow a seamless user experience irrespective of the applicant tracking system (ATS) in use. In particular, different employers may use different applicant tracking systems or switch between applicant tracking systems. There is no unified mechanism that provides a user with the ability to transfer a job application to themselves at another device, such as through email. In addition, individual job boards may require that a user create an account in order to access any persistence or forwarding services.

Employers also lack an automated, provider-agnostic method for collecting contact information in order to engage candidates at a later date. In summary, solutions based only on individual job boards accessed through a web site or app provide only transactional, one-off engagement.

To address these and other limitations of alternative systems, the present disclosure provides various systems and methods that enable seamless transitioning of job applications between multiple platforms and allow persistent interaction by an employer with a user. Various embodiments provide an ATS-agnostic solution enabling an employer to provide a job application that is locatable via various mobile access methods, while being made available for completion on a desktop or more robust platform. Various embodiments provide a job feed to various search engines and job aggregators, for example through an XML, or RSS feed.

The systems and methods of the present disclosure are particularly useful for employers that lack a custom mobile app for job applications. By providing integration with third party systems, the present disclosure leverage the increase in market penetration of job search engines. At the same time, an employer is able to gather completion data and increase long term engagement with a potential job applicant. Through follow-up emails, an employer can provide job-specific links, additional information about a given position and organization, and other persuasive material. Configurable email reminders, to complete a given job application or to apply for additional positions allow ongoing outreach.

The systems and methods of the present disclosure obviate the need for a user to create an account on multiple job boards or search services. In particular, follow-up on a new platform does not require a user account, and all state is managed on the server side.

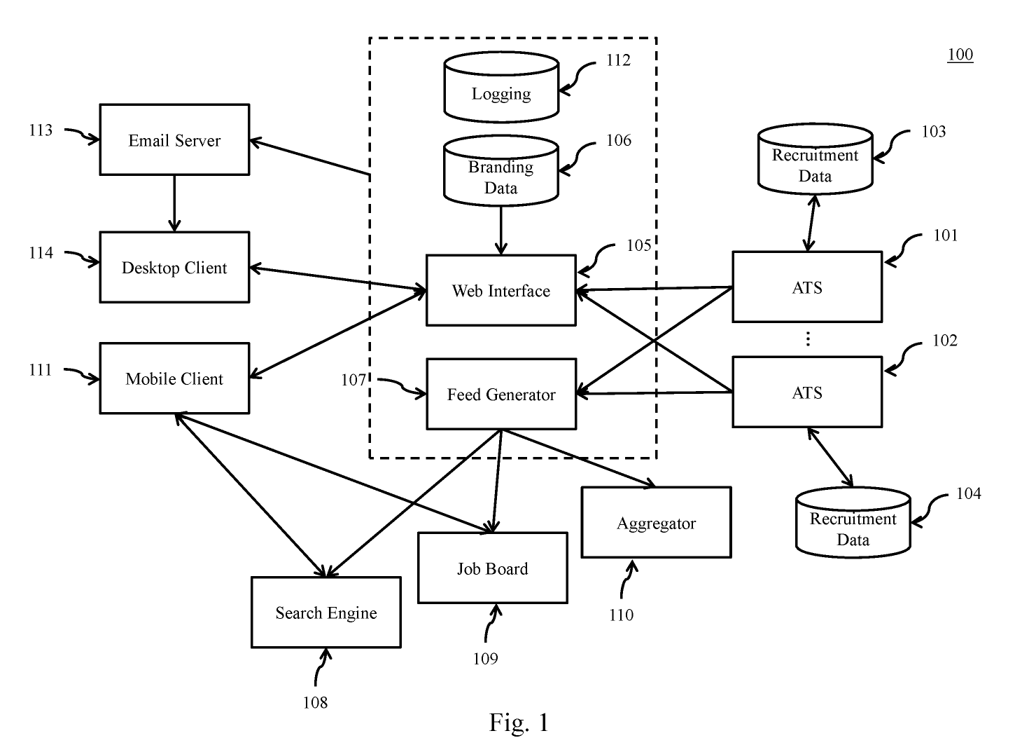

Referring to FIG. 1, a system for providing a unified cross-platform job application interface is illustrated according to embodiments of the present disclosure. Applicant tracking systems (ATS) 101 . . . 102 read recruitment data from data stores 103 . . . 104. In various embodiments, recruitment data includes job postings, applicant data, resumes, and interview data. In some embodiments, applicant tracking systems 101 . . . 102 correspond to individual employers. Applicant tracking systems 101 . . . 102 provide job posting data for serving via web interface 105. In various embodiments, web interface formats a given job posting based upon branding data 106. Branding data 106 may include logos, color schemes, page templates, or other visual elements to customize the presentation of a job posting.

In some embodiments, applicant tracking systems 101 . . . 102 make job posting data available via an XML or RSS feed. In some embodiments, job posting data is made available via a SOAP or other XML/RPC interface.

Applicant tracking systems 101 . . . 102 provide job posting data to feed generator, which formats each job posting for further provision to search engine 108, job board 109, or aggregator 110. In some embodiments, the formatting includes conforming a job posting to the published specifications of each of search engine 108, job board 109, or aggregator 110. In some embodiments, the formatted job posting is provided via XML or RSS feed. In some embodiments, feed generator 107 exports a SOAP or other XML/RPC interface. As set forth in further detail below, formatting of the job posting may also include the addition of a per-job URL corresponding to a job page accessible through web interface 105.

A user may locate a given job posting via mobile client 111 by accessing search engine 108, job board 109, or aggregator 110. A user is directed to web interface 105, where further contact information is collected. In some embodiments, a user is prompted for an email address. In other embodiments, an email address is automatically collected from client side state information such as a cookie or other token. In some embodiments, a user is directed to a job application that may be completed via web interface 105, or that requires download and completion offline. In some embodiments, a beacon is provided for inclusion in the job application so that completion can be tracked and logged to data store 112 for later reporting. It will be appreciated that including a beacon in the completion page of a job application allows integration with a broad range of third party systems, such as applicant tracking systems 101 . . . 102. In particular, a pixel beacon may be embedded in a success page provided by applicant tracking systems 101 . . . 102, but served from web interface 105. In this way, notice may be received of completion notwithstanding that application handling is performed by a third party system.

In some embodiments, if a user views a job application, but does not complete it, a follow up email is generated and sent via server 113. A user may receive a follow up email at desktop client 114. The follow-up email may include a link back to the in-progress application. In this way, an application that was found from mobile client 111 can be completed from desktop client 114, whether via web interface 105 or within applicant tracking systems 101 . . . 102.

Accordingly, an employer is able to better engage with users unable to presently complete an employment application due to, for example, mobile device limitations. This solution is particularly suitable for recruitment marketers, and combines an output file suitable for interoperability with third party systems, automatically generated, job-specific landing pages capable of capturing candidates' email addresses, and automated communications containing the specific job link in which the candidate expressed an interest.

By combining these methods, employers experience a significant increase in employment applications, with internal testing demonstrating a lift of up to 50%. This approach maximizes the number of employment applications completed by web site visitors. If the employer does not have a mobile-friendly application, the present disclosure enables them to send a copy of the application to the user for completion on a desktop computer. These solutions allow employers to better engage with candidates that are not users of the referenced service providers.

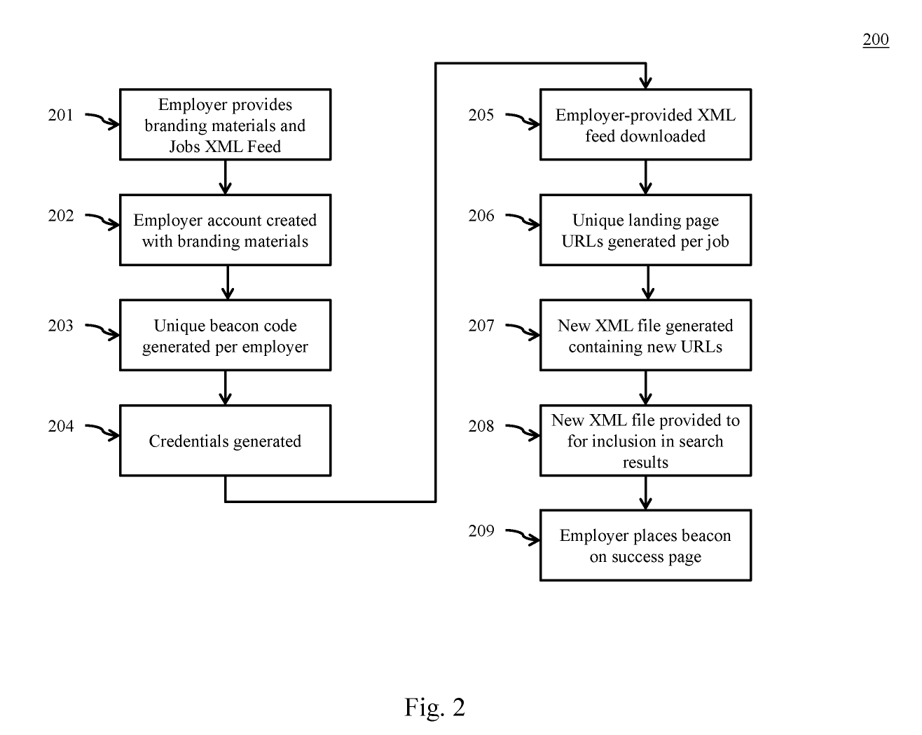

With reference now to FIG. 2, a method of providing a unified cross-platform job application interface is illustrated according to embodiments of the present disclosure. At 201, an employer provides branding materials and access to current jobs postings. In some embodiments, the job postings are provided as an XML or RSS feed. At 202, the employer is provided with an account. At 203, a unique token is generated for the employer. At 204, login credentials are generated and provided to the employer.

At 205, the employer job postings are ingested. In some embodiments, ingesting the job postings comprises reading an XML file provided by the employer, for example from an applicant tracking system. Each job posting comprises information about a job opening, such as job title, a brief description, the location, or a link to the full application.

At 206, a unique landing page and associated URL are created for each job. In some embodiments, the landing page merges the job posting information with company-specific branding provided by the employer, such as a logo, company information, an embedded video or a header to match their web site design. In some embodiments, the landing page is generated in advance of need, while in some embodiments the landing page is generated dynamically upon request. In addition to customizing the look and feel of the landing page, custom email layouts are also generated based on the branding information. Customized email layouts may be used in the various email responses and automatic email reminders set forth herein.

At 207, a new feed is generated that contains the landing page URLs generated for each job posting. In some embodiments, the new feed comprises an XML or RSS feed. At 208, the feed is provided to the employer, or any of various third party search engines, job aggregators, or job boards. In some embodiments, the feed is provided by making an XML file available at a provided URL. In some embodiments, an output XML file is substantially similar to an input XML except for the replacement or job URLs. The employer may then update any third party vendors, such as advertising platforms, with the URL of the new XML feed.

At 208, a pixel beacon is placed on the employer's application success page in order to track which users completed the application. When loaded, the pixel beacon provides a notification that the success page was loaded. In various embodiments, the pixel beacon allows control of outgoing reminder emails as set forth below. In various embodiments, the pixel beacon is also used to compile reporting for the employer. It will be apparent that the present methods are suitable for use with a variety of underlying applicant tracking systems with a variety of workflows. Accordingly, although various exemplary embodiments are described with reference to a success page, it will be appreciated that a pixel beacon or other access tracking device may be included in a variety of alternative user interface components according to various embodiments.

Once activity has been logged, an employer may access a report of activity for each job posting. As set forth below, emails are generated and sent with job links and employer branding as candidates sign up.

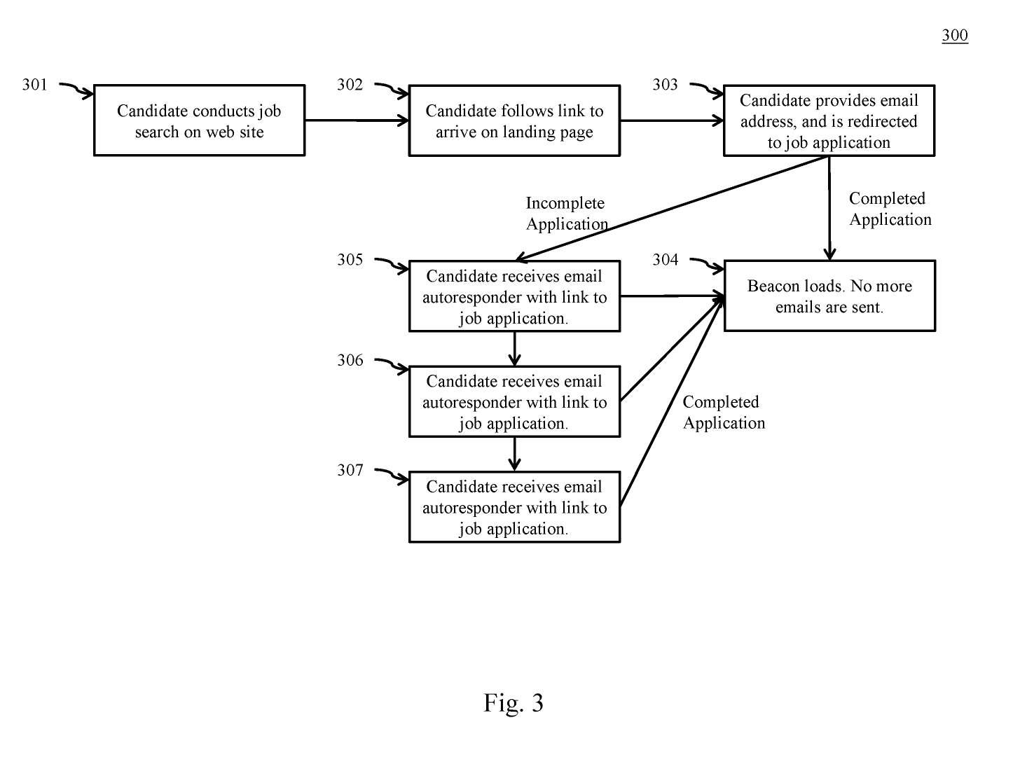

With reference now to FIG. 3, a method for cross-platform tracking of a job applicant is illustrated according to various embodiments. At 301, a candidate conducts a job search via a web site or app. As noted above, the search may be conducted on a mobile device that does not support a full range of functionality. At 302, when a candidate follows a provided link to view a job description, the user is directed to a custom landing page generated as discussed above. The page contains the relevant job information, and asks the user if they would like to provide an email before viewing the application. At 303, the user can either provide an email and receive emailed links, or opt-out of the emails. Regardless, the user is then redirected to the full application.

At 304, if the application is completed, the pixel beacon is triggered, reporting back to that email reminders or follow-ups should not be sent. At 305, if the candidate does not complete the application, a follow up email is sent with a link to the employer's job application. In some embodiments, the initial follow-up is sent shortly after the initial viewing of the application, for example after one hour. In this way, a seamless follow-up is provided for a user that abandons a job application after an initial viewing. At 306, if the application is not completed after a predetermined interval, a second reminder is sent. At 307, if the application is not completed after a second predetermined interval, a final reminder is sent. In some embodiments, the predetermined interval is one day, however, various alternative intervals may be use according to various embodiments of the present disclosure. In some embodiments, an opt-out link is provided in the emails to cancel the reminders. If the application is completed at any time, future emails are cancelled.

It will be appreciated that the recording of beacon impressions enables compilation of comprehensive statistics regarding application completion. For example, an employer can view reporting displaying how many clicks and applications are completed by day. Similarly, the application completion rate can be measured with and without the landing pages described herein through A/B testing. In particular, traffic may be split between an unmodified ATS-hosted landing page and a landing page as described herein. In this way, beacons may be used to generate comprehensive statistics to the employer regarding the number of applications completed with and without the systems and methods provided herein.

In some embodiments, additional reminders may be sent to a user after initial viewing. For example, after a predetermined interval, links to related jobs may be sent. In some embodiments, similarity may be determined based on proximity, job title, or job description. In some embodiments, the predetermined interval is one week. For example, a weekly follow up email may be sent that includes all jobs within a fixed radius, for example 25 miles

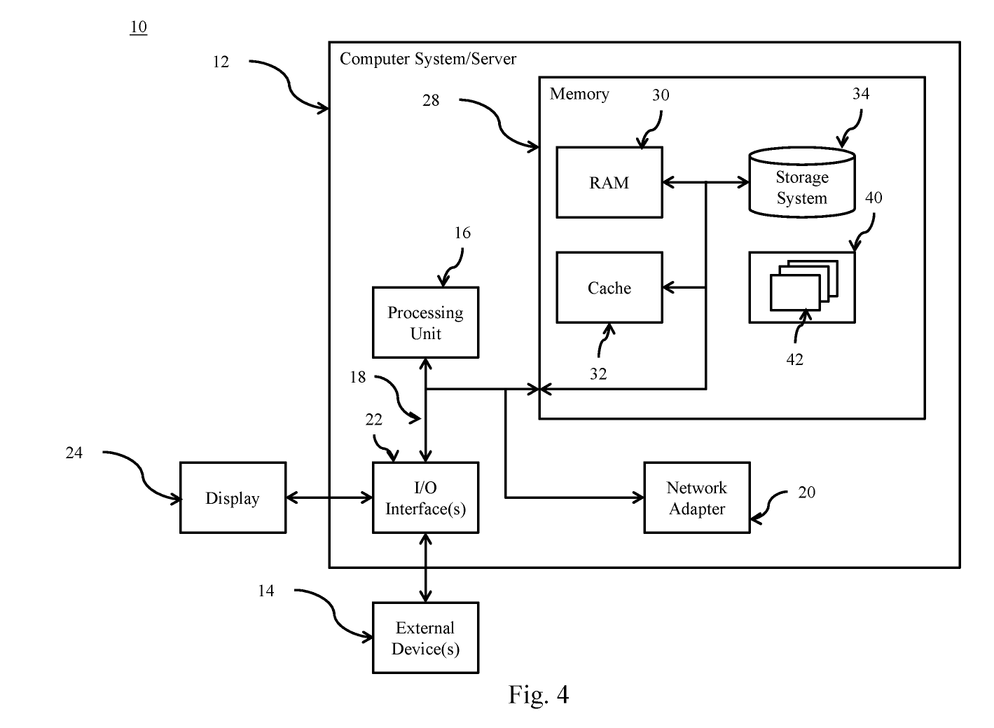

Referring now to FIG. 4, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a plurality of job descriptions from an external system;
for each of the plurality of job descriptions, generating a landing page;
making each landing page available via the internet at a URL;
generating a feed comprising the URL of each landing page;
making the feed available via the internet at a URL;
receiving a user request for at least one of the landing pages via the internet;
collecting contact information from the user;
providing the landing page to the user, the landing page comprising one of the plurality of job descriptions;
detecting that the user has not completed a job application correspond to the one of the plurality of job descriptions;
providing the user a link to complete the job application.

2. The method of claim 1, wherein the plurality of job descriptions are received from an applicant tracking system.

3. The method of claim 1, wherein the plurality of job descriptions are receives in an XML file.

4. The method of claim 1, wherein generating the landing pages comprises:
reading branding data;
applying the branding data to the landing pages.

5. The method of claim 1, wherein the feed comprises an XML, file.

6. The method of claim 1, wherein the contact information is an email address.

7. The method of claim 1, wherein collecting the contact information comprises prompting the user for an email address prior to displaying further

8. The method of claim 1, further comprising:
providing a beacon for inclusion in the job application, and wherein detecting that the user has not completed the job application comprises determining that the beacon has not been triggered.

9. The method of claim 1, wherein providing the user the link comprises sending an email comprising the link.

10. The method of claim 9, wherein sending the email comprises:
reading branding data;
applying the branding data to the landing pages.

11. The method of claim 1, wherein branding data comprises logos, color schemes, or page templates.

12. The method of claim 1, further comprising:
again providing the user the link to complete the job application after a predetermined period.

13. The method of claim 1, further comprising:
providing the user a link to at least one additional related job application after a predetermined period.

14. A computer program product for providing a cross-platform job application, the computer program product comprising a computer readable storage medium having program instructions embodied therewith, the program instructions executable by a processor to cause the processor to perform a method comprising:
receiving a plurality of job descriptions from an external system;
for each of the plurality of job descriptions, generating a landing page;
making each landing page available via the internet at a URL;
generating a feed comprising the URL of each landing page;
making the feed available via the internet at a URL;
receiving a user request for at least one of the landing pages via the internet;
collecting contact information from the user;
providing the landing page to the user, the landing page comprising one of the plurality of job descriptions;
detecting that the user has not completed a job application correspond to the one of the plurality of job descriptions;
providing the user a link to complete the job application.
